(19) United States
(12) Patent Application Publication
(10) Pub. No.: US 2026/0073719 A1
(43) Pub. Date: Mar. 12, 2026

(54) CONSTRUCTING DYNAMIC ENVIRONMENT DATA WITH AUTOMATED ANNOTATION

(71) Applicant: Field AI, Inc., Mission Viejo, CA (US)

(72) Inventors: Amirreza SHABAN, Seattle, WA (US); Samuel TRIEST, Pittsburgh, PA (US); Chanyoung CHUNG, Santa Ana, CA (US); David Fan, Lake Forest, CA (US)

(73) Assignee: Field AI, Inc., Mission Viejo, CA (US)

(21) Appl. No.: 19/326,060

(22) Filed: Sep. 11, 2025

Related U.S. Application Data
(60) Provisional application No. 63/693,830, filed on Sep. 12, 2024.

(51) Int. Cl. G06V 20/70; G06T 17/00; G06T 19/00; G06V 10/26

(52) U.S. Cl. CPC G06V 20/70; G06T 17/00; G06T 19/00; G06V 10/26

(57) ABSTRACT

In order to construct dynamic environment data with an automated annotation, a 3D model of an environment is first constructed using sensors located on a machine moving through the environment. The sensors include a first sensor to obtain point cloud data of the environment, a second sensor to obtain 2D images of an object or feature in the environment from different perspectives, and a third sensor to monitor positions and orientations of the machine. Once the 3D model is constructed, an annotated one of the 2D images and a non-annotated one of the 2D images are projected onto the 3D model and aligned with one another. The annotation is then transferred from the annotated 2D image to the non-annotated 2D image to convert the non-annotated 2D image into a second annotated 2D image. The second annotated 2D image is re-projected onto a 2D plane.

### CROSS-REFERENCE TO RELATED APPLICATION

This application claims priority to and the benefit of the filing date of provisional U.S. Patent Application No. 63/693,830, entitled “SYSTEM AND METHOD FOR CONSTRUCTING DYNAMIC ENVIRONMENT DATA WITH AUTOMATED ANNOTATION,” and filed on Sep. 12, 2024, the entire contents of which is hereby expressly incorporated herein by reference.

### TECHNICAL FIELD

Implementations of the present disclosure relate to automated annotation systems and more particularly relate to a system, method and computer-program product for constructing dynamic environment data with an automated annotation.

### BACKGROUND

The automated annotation systems have become increasingly crucial in various fields such as robotics, computer vision, and machine learning. An ability to quickly and accurately annotate large datasets is fundamental for training Artificial Intelligence (AI) models, especially in environments that require real-time decision-making and analysis. In construction sites, accurate and timely annotations are essential for monitoring, safety, and operational efficiency. Traditional manual labeling of one or more images and data is labor-intensive, prone to inconsistencies, and fails to keep pace with rapid accumulation of new data.

Conventional methods for the annotation involve manual efforts where human annotators meticulously annotate objects in one of: the one or more images and one or more videos. This approach is slow and expensive, particularly when dealing with extensive datasets. The human annotators need to be trained to ensure consistency, and this approach becomes a bottleneck in rapidly evolving environments. Additionally, manual annotation may lead to inconsistencies due to human error and subjective judgment, impacting an overall quality of annotated data.

Light detection and ranging (LiDAR) and camera-based methods have been employed to improve an annotation efficiency. Nevertheless, integrating LiDAR data with the one or more images to create the consistent annotations remains challenging. A disparity between the types of data collected may lead to inaccuracies in the annotation process.

Multi-view annotation systems capture the one or more images from various angles and perspectives. While the multi-view annotation systems assist in providing a more comprehensive view of the environment, the multi-view annotation systems require manual synchronization and alignment of the annotations across different views. The multi-view annotation systems are complex and error-prone, especially in dynamic and cluttered environments where the objects may be partially occluded or displaced.

Some existing systems construct three-dimensional (3D) models of the environment using one or more point clouds and other sensor data to facilitate the annotation. The 3D models assist in understanding spatial relationships and object positioning. Nevertheless, current solutions struggle with real-time updates and dynamic environment adaptations, leading to outdated and inaccurate annotations as the environment changes.

Real-time annotation systems aim to provide immediate annotations of the objects as the objects are detected. The real-time annotation systems face difficulties in maintaining annotation consistency across multiple images and viewpoints. A dynamic nature of real-world environments introduces variability that challenges the ability of the real-time annotation systems to deliver accurate and consistent annotations.

Vision Foundation Models (VFMs) have demonstrated potential in enhancing feature extraction and object recognition. These VFMs provide semantic understanding and high-quality features, but the integration of the VMFs into the real-time annotation systems is limited by computational complexity and the need for extensive training data. Moreover, adapting the VFMs to work seamlessly with real-time data and dynamic environments remains a challenge.

Proper handling of occlusions, where the objects are partially or fully blocked from view, is a significant issue in real-time annotation systems. Existing methods struggle to accurately annotate the occluded objects, leading to incomplete or erroneous annotations. Traditional systems may lack robust mechanisms for synchronizing the annotations across different viewpoints, leading to discrepancies.

There are various technical problems with the existing systems in the prior art. In the existing technology, integrating point clouds with one or more images results in alignment challenges, leading to inaccuracies in the annotations. The real-time annotation systems struggle with the technical problem of maintaining consistency across multiple viewpoints due to the complexity of synchronizing the annotations while accounting for dynamic changes in the environment. Handling the occlusions remains problematic, as many existing systems fail to accurately estimate and annotate the hidden objects. Additionally, the computational demands of incorporating VFMs are high, creating difficulties in real-time application and requiring extensive resources for effective integration.

Therefore, there is a need for a technical solution of a system to address the aforementioned technical problems by integrating a dynamic 3D model construction with automated annotation and real-time annotation propagation. The system should ensure the consistent and accurate annotations across the multiple viewpoints while effectively handling the occlusions and leveraging VFMs for enhanced feature extraction.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In one general aspect, the instant disclosure presents a system for constructing dynamic environment data with an automated annotation, including a processor and a memory in communication with the processor, the memory including executable instructions that, when executed by the processor alone or in combination with other processors, cause the system to perform certain functions. These functions include constructing a three-dimensional (3D) model of an environment, using a plurality of sensors located on a machine configured to move through the environment, wherein the plurality of sensors include a first sensor configured to obtain point cloud data of the environment, a second sensor configured to obtain a plurality of two dimensional (2D) images of an object or feature in the environment from different perspectives as the machine moves through the environment, and a third sensor configured to monitor position and orientation of the machine as the machine moves through the environment, receiving a first one of the 2D images of the object or feature in the environment, obtained by the second sensor, wherein the first one of the 2D images is an annotated 2D image which includes an annotation identifying the object or feature, projecting the annotated 2D images with the annotation onto the 3D model, and projecting a second one of the 2D images of the object or feature, obtained by the second sensor from a different perspective of the object or feature, onto the 3D model, wherein the second one of the 2D images is a non-annotated 2D image. After the 2D images are projected onto the 3D model, the functions further include aligning the non-annotated 2D image projected onto the 3D model with the annotated 2D image projected onto the 3D model, transferring the annotation from the annotated 2D image projected onto the 3D model to the non-annotated 2D image projected onto the 3D model after the annotated 2D image and the non-annotated 2D image are aligned with one another on the 3D model to convert the non-annotated 2D image to a second annotated 2D image, and re-projecting the non-annotated 2D image as the second annotated 2D image onto a 2D plane.

In another general aspect, the instant disclosure presents a method for constructing dynamic environment data with an automated annotation, including constructing a three-dimensional (3D) model of an environment, using a plurality of sensors located on a machine configured to move through the environment, wherein the plurality of sensors include a first sensor configured to obtain point cloud data of the environment, a second sensor configured to obtain a plurality of two dimensional (2D) images of an object or feature in the environment from different perspectives as the machine moves through the environment, and a third sensor configured to monitor position and orientation of the machine as the machine moves through the environment, receiving a first one of the 2D images of the object or feature in the environment, obtained by the second sensor, wherein the first one of the 2D images is an annotated 2D image which includes an annotation identifying the object or feature, projecting the annotated 2D images with the annotation onto the 3D model, and projecting a second one of the 2D images of the object or feature, obtained by the second sensor from a different perspective of the object or feature, onto the 3D model, wherein the second one of the 2D images is a non-annotated 2D image. Once the 2D images have been projected onto the 3D model, the method further includes aligning the non-annotated 2D image projected onto the 3D model with the annotated 2D image projected onto the 3D model, transferring the annotation from the annotated 2D image projected onto the 3D model to the non-annotated 2D image projected onto the 3D model after the annotated 2D image and the non-annotated 2D image are aligned with one another on the 3D model to convert the non-annotated 2D image to a second annotated 2D image, and re-projecting the non-annotated 2D image as the second annotated 2D image onto a 2D plane.

In yet another general aspect, the instant disclosure presents a computer-readable storage medium having instructions stored thereon that, when executed by a processing system, perform a method including constructing a three-dimensional (3D) model of an environment, using a plurality of sensors located on a machine configured to move through the environment, wherein the plurality of sensors include a first sensor configured to obtain point cloud data of the environment, a second sensor configured to obtain a plurality of two dimensional (2D) images of an object or feature in the environment from different perspectives as the machine moves through the environment, and a third sensor configured to monitor position and orientation of the machine as the machine moves through the environment, receiving a first one of the 2D images of the object or feature in the environment, obtained by the second sensor, wherein the first one of the 2D images is an annotated 2D image which includes an annotation identifying the object or feature, projecting the annotated 2D images with the annotation onto the 3D model, and projecting a second one of the 2D images of the object or feature, obtained by the second sensor from a different perspective of the object or feature, onto the 3D model, wherein the second one of the 2D images is a non-annotated 2D image. Once the 2D images have been projected onto the 3D model, the method further includes aligning the non-annotated 2D image projected onto the 3D model with the annotated 2D image projected onto the 3D model, transferring the annotation from the annotated 2D image projected onto the 3D model to the non-annotated 2D image projected onto the 3D model after the annotated 2D image and the non-annotated 2D image are aligned with one another on the 3D model to convert the non-annotated 2D image to a second annotated 2D image, and re-projecting the non-annotated 2D image as the second annotated 2D image onto a 2D plane.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates an exemplary block diagram representation of a network architecture depicting a system for constructing dynamic environment data with an automated annotation, in accordance with an implementation of the present disclosure.

FIG. 2 illustrates an exemplary block diagram representation of the system as shown in FIG. 1 for constructing the dynamic environment data with the automated annotation, in accordance with an implementation of the present disclosure.

FIG. 3 illustrates an exemplary flow diagram representation of the system for constructing the dynamic environment data with the automated annotation, utilizing data from a machine traversing through the environment, in accordance with an implementation of the present disclosure.

FIG. 4 illustrates an exemplary flow diagram of the system for utilizing an input annotated 2D image in conjunction with a 3D model constructed from data obtained by the machine traversing through the environment, to automatically label non-annotated 2D images of the same object or feature as the annotated 2D image to convert the non-annotated 2D images into automatically annotated new 2D images, in accordance with an implementation of the present disclosure.

FIG. 5 shows a diagram of an example implementation of constructing modules in one or more processors, shown in FIGS. 1 and 2, for providing a 3D model with dynamic environment data to provide automated annotation of non-annotated input 2D images, in accordance with aspects of the disclosure.

FIG. 6 shows a flowchart for constructing the 3D model with dynamic environment data with automated annotation in accordance with aspects of the disclosure.

FIG. 7 is a block diagram illustrating an example software architecture, various portions of which may be used in conjunction with various hardware architectures herein described in accordance with aspects of the disclosure.

FIG. 8 is a block diagram illustrating components of an example machine configured to read instructions from a machine-readable medium and perform any of the features described herein in accordance with aspects of the disclosure.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

As will be described in greater detail below, the system, method and computer program product that will be described herein provides dynamic environment data with an automated annotation. The first step for achieving this is constructing a 3D model of an environment using sensors located on a machine moving through the environment. The sensors include a first sensor to obtain point cloud data of the environment, a second sensor to obtain 2D images of an object or feature in the environment from different perspectives, and a third sensor to monitor positions and orientations of the machine. Once the 3D model of the environment is constructed, an annotated one of the 2D images (in which an image is taken by the second sensor and annotated by a user or an annotating device) and one or more non-annotated ones of the 2D images (also taken by the second sensor) are projected onto the 3D model and aligned with one another on the 3D model. The annotation is then transferred from the annotated 2D image to the one or more non-annotated images to convert the non-annotated 2D images to second annotated 2D images. After the annotation has been transferred, the second annotated 2D images are re-projected onto respective 2D planes.

As noted above, the present disclosure describes systems, methods and computer program products for constructing dynamic environment data with automated annotations. In this regard, the system includes one or more hardware processors and a memory unit. The memory unit is operatively coupled to the one or more hardware processors. The memory unit includes a plurality of subsystems in the form of machine-readable instructions executable by the one or more hardware processors. The plurality of subsystems includes a data-obtaining subsystem, a three-dimensional (3D) model construction subsystem, and an annotation propagation subsystem.

As will be discussed in greater detail below, the data-obtaining subsystem is configured to obtain sensor data necessary for creating a comprehensive understanding of an environment around one or more machines. The 3D model construction subsystem is configured to create a detailed and accurate three-dimensional (3D) model (e.g., the dynamic environment data) of the environment based on sensor data. The 3D model construction subsystem is configured to provide annotations by identifying objects based on their trained capabilities. The annotation propagation subsystem is configured to seamlessly transfer the annotations from one image to other images by leveraging the 3D model of the environment.

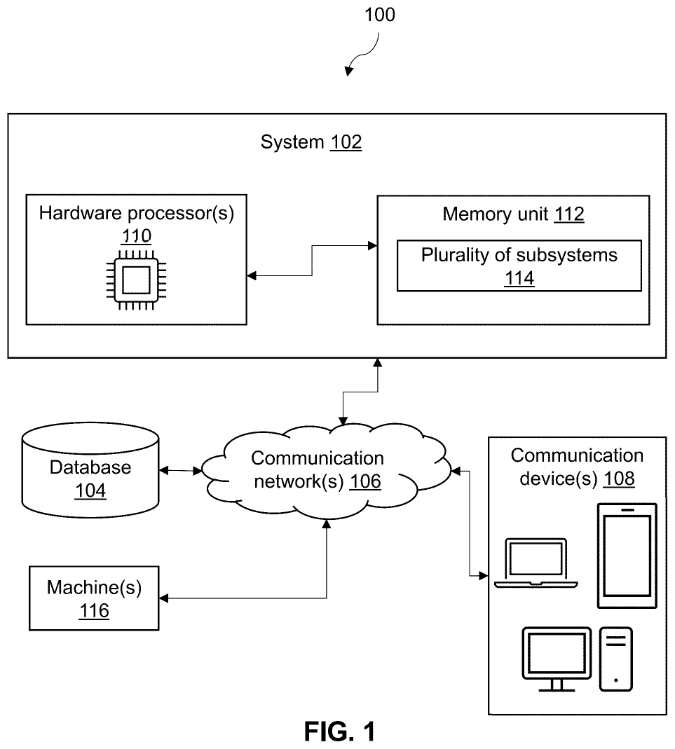

Referring now to the drawings, and more particularly to FIG. 1 through FIG. 6, where similar reference characters denote corresponding features consistently throughout the figures, there are shown preferred implementations and these implementations are described in the context of the following exemplary system and/or method.

FIG. 1 illustrates an exemplary block diagram representation of a network architecture 100 depicting a system 102 for constructing dynamic environment data with automated annotations, in accordance with an implementation of the present disclosure. The network architecture 100 may include the system 102, one or more communication networks 106, a database 104, and one or more communication devices 108. The system 102 may be communicatively coupled to the database 104, and the one or more communication devices 108 via the one or more communication networks 106. The one or more communication networks 106 may be, but not limited to, a wired communication network and/or a wireless communication network.

The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including 4G (fourth generation), 5G (fifth generation), and 6G (sixth generation) networks), Bluetooth, ZigBee, long-range wide area network (LoRaWAN), satellite communication, radio frequency identification (RFID), advanced IoT protocols, mesh networks, non-terrestrial networks (NTNs), near field communication (NFC), and the like.

The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including 4G (fourth generation), 5G (fifth generation), and 6G (sixth generation) networks), Bluetooth, ZigBee, long-range wide area network (LoRaWAN), satellite communication, radio frequency identification (RFID), advanced IoT protocols, mesh networks, non-terrestrial networks (NTNs), near field communication (NFC), and the like.

The one or more communication networks 106 are configured to facilitate seamless data exchange and communication between the system 102 and the database 104 for real-time data analysis. In an exemplary implementation, the database 104 may include, but not limited to, storing, and managing data related to the dynamic environment and annotations of objects present in an environment. The database 104 serves as a central repository for all relevant data, enabling efficient data retrieval and analysis to support decision-making processes. The database 104 also facilitates the construction of the dynamic environment data with the automated annotation, ensuring that the system 102 operates at peak efficiency. Furthermore, the database 104 may manage user access controls, configuration settings, and system logs, providing a comprehensive solution for data management and security within the network architecture 100.

One or more machines 116 are operatively connected to the system 102 via the one or more communication networks 106. The one or more machines 116 may be, but are not limited to, at least one of a: quadruped robot, wheeled robot, biped robot, drone, vehicle, and the like.

In an exemplary implementation shown in FIG. 1, the one or more communication devices 108 may represent various network endpoints, such as, but not limited to, user devices, mobile devices, smartphones, Personal Digital Assistants (PDAs), tablet computers, phablet computers, wearable computing devices, Virtual Reality/Augmented Reality (VR/AR) devices, laptops, desktops, display interface panels, control panels, human machine interface panels, liquid crystal display (LCD) screens, light-emitting diode (LED) screens, and the like. The one or more communication devices 108 are configured to function as an intermediate unit between the system 102 and one or more users. The one or more communication devices 108 are equipped with a user interface that allows the one or more users to interact with the system 102. The user interface may include graphical displays, touchscreens, voice recognition, and other input/output mechanisms that facilitate easy access to data and control functions. Any other instructions may be provided by the one or more users to the system 102 via the user interface.

Though few components and a plurality of subsystems 114 are disclosed in FIG. 1, there may be additional components and subsystems which are not shown, such as, but not limited to, ports, routers, repeaters, firewall devices, network devices, additional databases, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the system 102, and the one or more communication devices 108 connected to the database 104, one skilled in the art can envision that the system 102, and the one or more communication devices 108 may be connected to several user devices located at various locations and several databases via the one or more communication networks 106.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will also recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

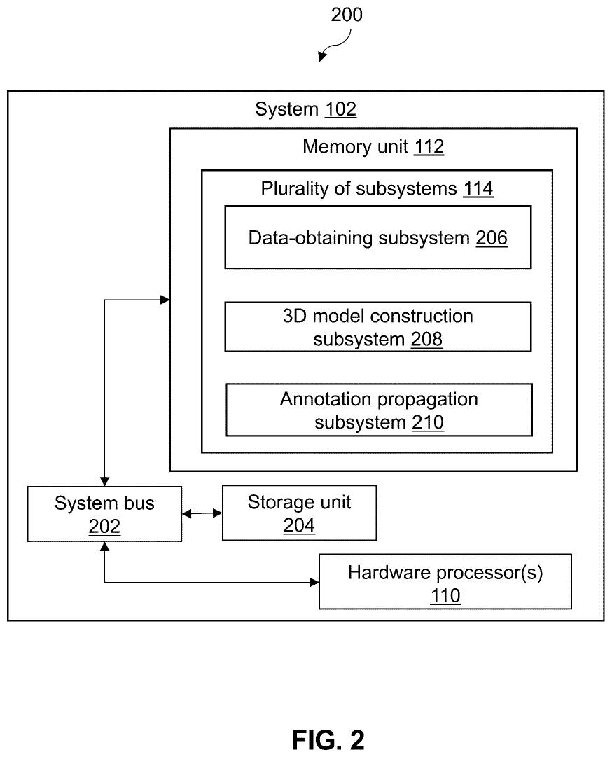

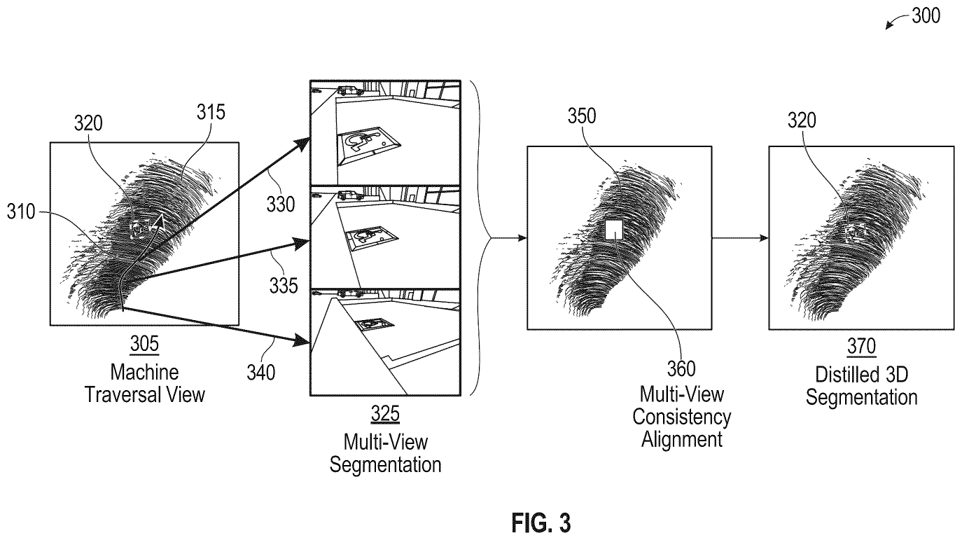

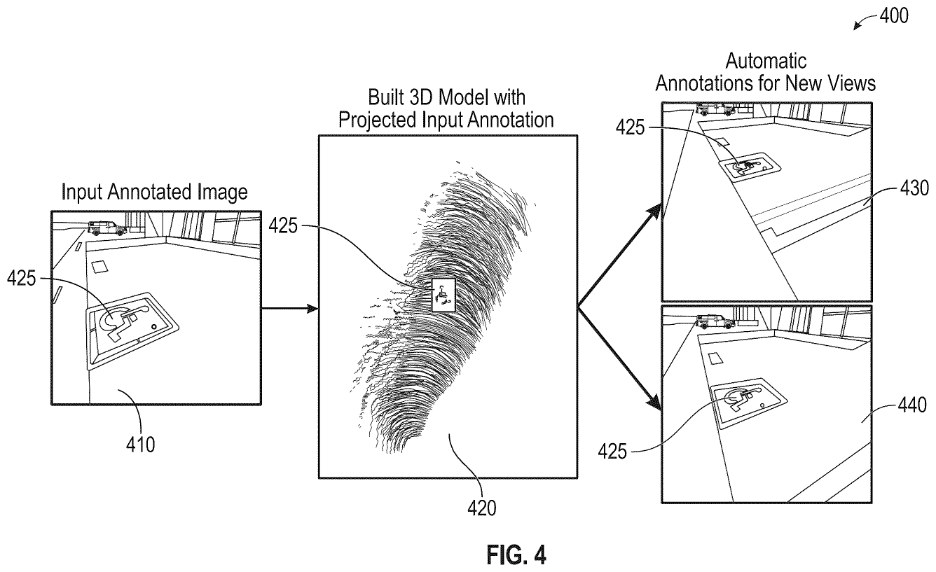

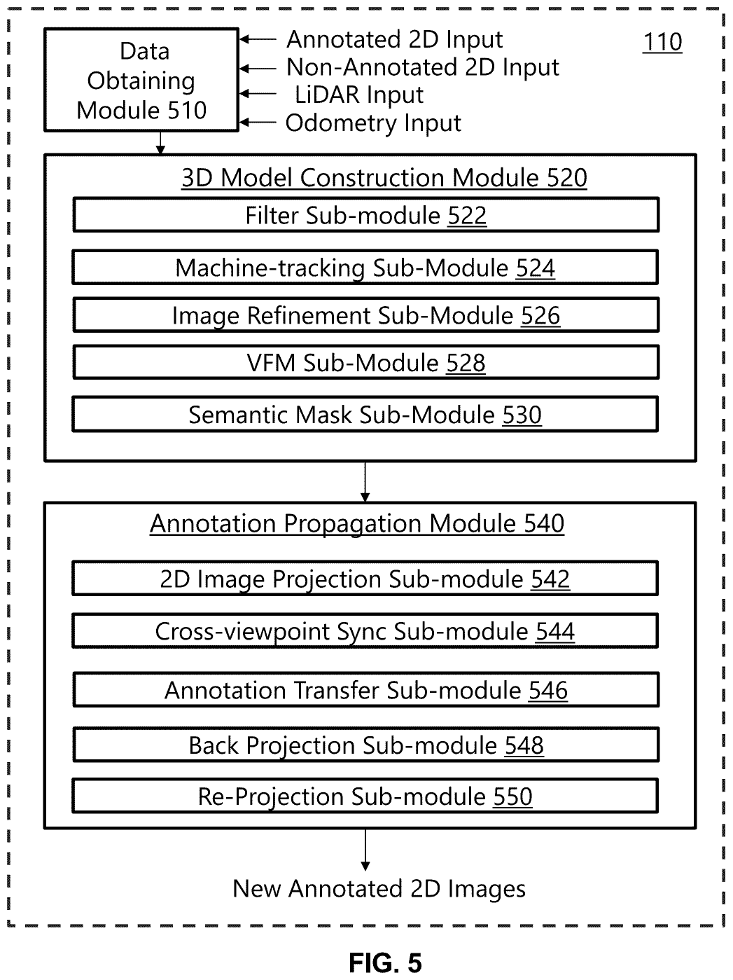

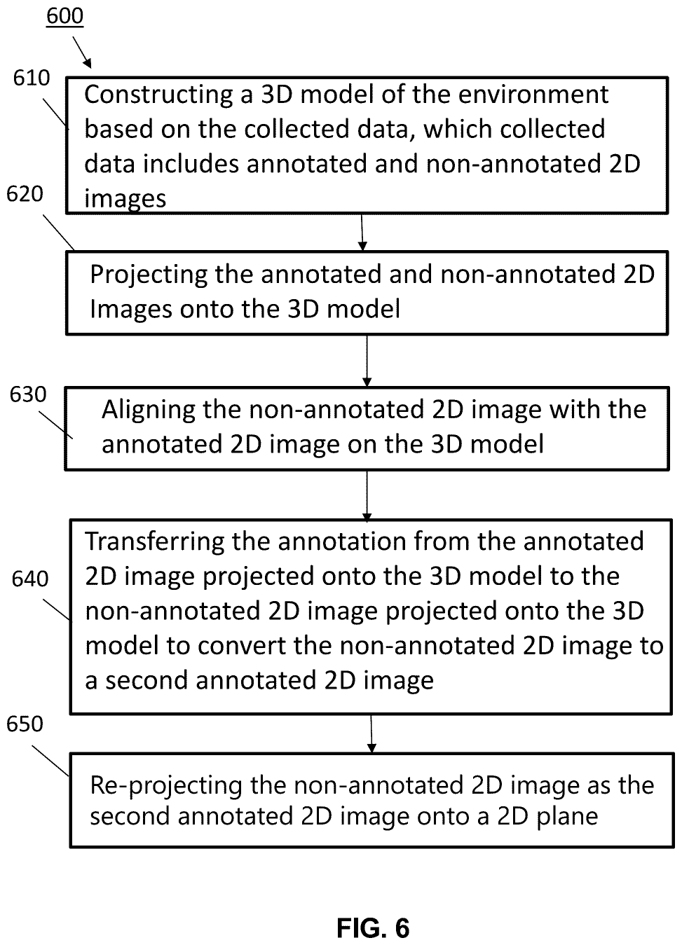

In the discussion which follows, FIGS. 2-6 provide an integrated description of an implementation of the system 102 of FIG. 1 to construct a 3D model 420 (e.g., see FIG. 4) having dynamic environment data, and using this 3D model as a basis for transferring annotations from an annotated 2D image to non-annotated images of the same object/feature taken from different viewpoints. In particular, FIG. 2 illustrates an exemplary block diagram representation 200 of the system 102 as shown in FIG. 1 for constructing the dynamic environment data with the automated annotation, in accordance with an implementation of the present disclosure. FIG. 3 illustrates an exemplary flow diagram representation 300 of the system for constructing the dynamic environment data with the automated annotation utilizing data from a machine traversing through the environment. FIG. 4 illustrates an exemplary flow diagram 400 of the system for utilizing an input annotated 2D image, in conjunction with a 3D model constructed from data obtained by the machine traversing through the environment, to automatically label previously non-annotated 2D images of the same object or feature. FIG. 5 shows a diagram of an example implementation of modules in one or more processors, shown in FIGS. 1 and 2, for providing a 3D model with dynamic environment data, based on the subsystems 206, 208 and 210 of the memory unit 112 of FIG. 2, to provide automated annotation of previously non-annotated input 2D images. FIG. 6 shows a flowchart 600 for constructing the 3D model with dynamic environment data with automated annotation using instructions from the memory unit 112 of FIG. 2 and the modules 510, 520 and 540 of the processor 110 shown in FIG. 5.

Turning first to FIG. 2, in the exemplary implementation of FIG. 2 the system 102 includes at least one of: one or more hardware processors 110, a memory unit 112, and a storage unit 204. The one or more hardware processors 110, the memory unit 112, and the storage unit 204 are communicatively coupled through a system bus 202 or any similar mechanism. The system bus 202 functions as a central conduit for data transfer and communication between the one or more hardware processors 110, the memory unit 112, and the storage unit 204. The system bus 202 facilitates the efficient exchange of information and the instructions, enabling a coordinated operation of the system 102. The system bus 202 may be implemented using various technologies, including but not limited to, parallel buses, serial buses, or high-speed data transfer interfaces such as, but not limited to, at least one of a: universal serial bus (USB), peripheral component interconnect express (PCIe), and similar standards.

The memory unit 112 is operatively connected to the one or more hardware processors 110. The memory unit 112 comprises the set of computer-readable instructions in the form of the plurality of subsystems 114. The plurality of subsystems 114 comprises a data-obtaining subsystem 206, a three-dimensional (3D) model construction subsystem 208, and an annotation propagation subsystem 210. As will be described in more detail below with reference to FIG. 5, the subsystems 206, 208 and 210 operate to control the operations of a data obtaining module 510, a 3D model construction module 520 and an annotation propagation module 540 of the one or more processors 110.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, one or more graphics processing unit (GPUs), one or more central processing units (CPUs), digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be the non-transitory volatile memory and the non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present implementation, the memory unit 112 includes the plurality of subsystems 114 stored in the form of machine-readable instructions on any of the above-mentioned storage media and may be in communication with and executed by the one or more hardware processors 110.

The storage unit 204 may be a cloud storage or the database 104 such as those shown in FIG. 1. The storage unit 204 may store, but not limited to, recommended course of action sequences dynamically generated by the system 102. The action sequences comprise data-obtaining, scene understanding, 3D model constructing, annotation propagating, and the like. The storage unit 204 may be any kind of database such as, but not limited to, relational databases, dedicated databases, dynamic databases, monetized databases, scalable databases, cloud databases, distributed databases, any other databases, graph databases, vector databases, and a combination thereof.

In an exemplary implementation, the data-obtaining subsystem 206 is configured to obtain sensor data necessary for creating a comprehensive understanding of the environment around the one or more machines 116. The sensor data may comprise, but not constrained to, at least one of: one or more point clouds, one or more images, odometry data, and the like. The one or more point clouds are generated by one or more Light Detection and Ranging (LiDAR) sensors (not shown). The one or more LiDAR sensors emit laser pulses to measure distances between the one or more machines 116 and the objects in its surroundings. The one or more point clouds are essential for capturing spatial relationships and dimensions of the objects.

A plurality of 2D images are captured by one or more on-board cameras (not shown), providing visual information of various objects and features of the environment from various angles and viewpoints. The one or more 2D images provide critical context and detail, such as color, texture, and specific visual cues. As will be discussed in more detail below, at least one of the 2D images from the camera(s) is annotated in accordance with the present disclosure (e.g., such as the annotated 2D image 410 of FIG. 4), while others of the 2D images of the same objects or features, taken from different perspectives, are not annotated.

Odometry data is obtained from one or more wheel encoders (not shown) and one or more inertial measurement units (IMUs). The one or more wheel encoders measure a rotation of wheels to estimate the distance traveled by the one or more machines 116. The one or more IMUs provide acceleration and angular velocity data to track changes in a position and an orientation of the one or more machines 116. The odometry data is vital for tracking an exact path and a location of the one or more machines 116 within the environment, ensuring that all data points are accurately referenced in space. The one or more LiDAR sensors, the one or more on-board cameras, the one or more wheel encoders, and the one or more IMUs are installed on the one or more machines 116. As shown in FIG. 5, a data obtaining module 510 of the one or more processors 110, receives a combination of data including the annotated 2D image(s), as shown by the image 410 in FIG. 4, the non-annotated 2D image(s), LiDAR, or related, input(s) and odometry input(s).

In the exemplary implementation of FIGS. 2 to 5, the 3D model construction subsystem 208 is configured to create a detailed and accurate three-dimensional (3D) model, such as the 3D model 420 shown in FIG. 4, of the environment based on the sensor data, utilizing the 3D model construction module 520 shown in FIG. 5. The 3D model 420 of the environment is the dynamic environment data. The 3D model construction subsystem 208 is configured aggregate the one or more point clouds, to construct the comprehensive 3D model 420 of the environment, by providing instructions to the 3D model construction module 520. The 3D model 420 serves as a foundational framework for understanding a spatial arrangement and a geometry of the environment.

FIG. 3 illustrates an exemplary flow diagram representation 300 of the system 102 for constructing the dynamic environment data with automated annotation, in accordance with an implementation of the present disclosure, utilizing the instructions provided by the subsystems 114 of FIG. 2 to the modules 510, 520 and 540 shown in FIG. 5.

In the exemplary implementation of FIG. 3, the flow diagram representation 300 includes a first machine traversal view 305 of a machine 116 traversing along a path 310 through an environment 315 to take a number of 2D images of an object 320 (in this case, a handicap symbol, such as could be provided on a parking space to indicate that the parking space is only for vehicles operated by drivers with a handicap permit). The 2D images can be provided in a multi-view segmentation 325 as multi-view segmentations 330, 335 and 340 showing multiple camera views of the same object 320 taken as the machine 116 travels along the path 310. As will be described below, the system 102 creates a 3D model (such as 3D model 420 in FIG. 4) which can align the multi-view segmentations 330, 335 and 340 in the 3D model 420 to provide a 3D point cloud representation 350 with a multi-view consistency alignment 360. This multi-view consistency alignment 360 can be used to transfer an annotation that is applied, for example, by a human operator to a 2D image of the object 320 represented by the segmentation 330, to the other segmentations 335 and 340 that are derived from 2D images of the object 320 that were not originally annotated.

More specifically, the 3D point cloud representation 350 with the multi-view consistency alignment 360 indicates a specific object or feature that is annotated in one of the segmentations 330 within the 3D space being aligned in the 3D space with the other segmentations 335 and 340, which are from non-annotated 2D images. In other words, the multi-view segmentation arrangement demonstrates how the system 102 can project the 3D annotation back into the 2D images of the segmentations 335 and 340 of non-annotated 2D images taken by the camera from different views, ensuring that the annotation is consistent across the multiple camera angles. The object 320 initially annotated in one view 330 is now correctly annotated in the other corresponding views 335 and 340, even when the object 320 appears differently due to perspective changes. The distilled 3D segmentation view 370 shows the handicap annotation on the object 320 that can then be re-projected to multiple annotated 2D images such as 430 and 440 shown in FIG. 4.

More specifically, FIG. 4 illustrates an exemplary flow diagram 400 of the system 102 for constructing the dynamic environment data with the automated annotation, in accordance with an implementation of the present disclosure. In the exemplary implementation of FIG. 4, the flow diagram 400 starts with an annotated image 410 (generally a 2D image from a camera mounted on the machine 116, although a 3D camera image could also be used), which serves as an initial annotated input for the system 102. The annotation 425 is provided on the object 320 (e.g., the handicap symbol discussed above with regard to FIG. 3). Then the flow diagram 400 displays the 3D model 420 with the projected input annotation indicated in the 3D model 420 as annotation 425. The 3D model 420 acts as a reference for propagating the annotation 425 across all other images of the object 320, which are non-annotated images, captured from different angles. The flow diagram 400 demonstrates the automatic propagation of the annotation 425 to new 2D images 430 and 440 taken of the object 320 from different views. There are different camera perspectives where the object is automatically annotated. The system 102 ensures that the annotations 425 are consistent and accurate, accounting for changes in the camera perspectives, occlusions, and different camera angles.

Turning next to FIG. 5, the 3D model construction module 520 can include a filter sub-module 522, a machine-tracking sub-module 524, an image refinement sub-module 526, a VFM sub-module 528 and a semantic mask sub-module 530. These modules 522, 524, 526, 528 and 530 in the processor 110 are all coupled to the 3D model construction subsystem 208 of the memory unit 114 to receive instructions from the subsystem 208 for carrying out the operations of each of the sub-modules 522-530. The 3D model construction subsystem 208 of FIG. 2 is configured to filter dynamic elements, via the filter sub-module 522, such as moving people and machinery from the 3D model 420, ensuring that the 3D model 420 focuses only on static, stable features of the environment. This filtering is useful for maintaining an accuracy and a reliability of the 3D model 420. Additionally, the 3D model construction subsystem 208 provides instructions to the machine-tracking sub-module 524 to employ the odometry data received by the data obtaining module 510 to continually track and update the position of the one or more machines 116 within the 3D model 420.

In an exemplary implementation, the 3D model construction subsystem 208 is configured to provide instructions to the image refinement sub-module 526 of the 3D module construction module 520 to refine the sensor data into high-quality three-dimensional features and the geometry that accurately depict the environment in the 3D model 420. The image refinement sub-module 526 utilizes hindsight experience of previous observations and accumulated data to improve the accuracy of current and future feature extraction processes, allowing the system 102 to learn and adapt over time. To further enhance the quality of the 3D model 420, the 3D model construction subsystem 208 provides instructions to the image refinement sub-module 526 to apply multi-view consistency, which integrates data from multiple viewpoints. This approach refines coarse image-space features, transforming the coarse image-space features in one of the received 2D images taken from one perspective into more precise 3D features and masks. This is accomplished by leveraging consistency and complementary information from other received 2D images taken across different views of the same object or feature have the coarse image-space features.

Additionally, the 3D model construction subsystem 208 is configured to provide instructions for one or more Vision Foundation Models (VFMs) such as Distillation of Knowledge with No Labels (DINO) and Contrastive Language-Image Pretraining (CLIP) to a VFM sub-module 528 of the 3D model construction module 520. Similarly, the 3D model construction subsystem 208 is configured to provide instructions for semantic masks from one or more Segment Anything models (SAMs) to a semantic mask sub-module 530 to bolster the quality of the 3D features and segmentation in the 3D model 420. The DINO is implemented by the VFM sub-module 528 to enhance a quality of 3D features of the 3D model 420 by learning meaningful representations from the one or more images. The DINO enables the system 102 to extract detailed visual features and improve segmentation accuracy, even in the absence of annotated datasets. The CLIP is used by the VFM sub-module 528 to enhance feature extraction and segmentation by leveraging its ability to recognize and differentiate between various objects and scenes. By incorporating the CLIP, the 3D model construction subsystem 208 and the VFM sub-module 528 may more accurately annotate and interpret the environment, supporting robust and detailed 3D model construction.

The one or more VFMs and the one or more SAMs implemented by the VFM sub-module 528 and the semantic mask sub-module 530 provide sophisticated, pre-trained features that assist in accurately distinguishing between different objects and surfaces within the environment. The one or more VFMs and the one or more SAMs provide the annotations by identifying the objects based on their trained capabilities.

In an exemplary implementation, the annotation propagation subsystem 210 is configured to provide instructions to the annotation propagation module 540 to seamlessly transfer the annotations from one image to other non-annotated images by leveraging the 3D model 420 of the environment. As shown in FIG. 5, the annotation propagation module 540 can include a 2D image projection sub-module 542, a cross-view point synchronization sub-module 544, an annotation transfer sub-module 546, a back projection sub-module 548, and a re-projection sub-module 550. Utilizing these sub-modules 542-550, an annotated 2D image, such as 410 shown in FIG. 4, can be utilized to transfer its annotation to non-annotated 2D images of the same objects or features of the environment, taken by the camera(s), from different distances and perspectives, to transfer the annotation 425 from the annotated 2D image to the non-annotated 2D images received by the data obtaining module 510.

Initially, when an object or feature in the environment is annotated in a single image of the one or more images (e.g., the annotated 2D image 410 shown in FIG. 4), the annotation propagation subsystem 210 provides instructions to the 2D image projection sub-module 542 to project the annotation 425 from the annotated 2D image 410 into the 3D model 420. This ensures that the annotation 425 is transferred from the annotated 2D image 410 to non-annotated 2D images and remains consistent and accurate across various perspectives. As will be discussed below, the annotation propagation module 540 includes a cross-viewpoint synchronization sub-module 544 and an annotation transfer sub-module 546 to align the different annotated and non-annotated 2D images of the same object or feature, and transfer the annotation 425 from the annotated image 410 to the non-annotated image(s).

The annotation propagation subsystem 210 is configured to include instructions for back projection procedures using a back projection sub-module 548 of the annotation propagation module 540. The back projection procedures refine projections, converting 3D embeddings back into 2D to achieve sharper predictions and precise label placement in the one or more images (annotated and non-annotated of the same object/feature). Additionally, the annotation propagation subsystem 210 provides the necessary instructions to the back projection sub-module 548 to handle occlusions by analyzing the 3D model 420 to estimate and manage potential obstructions, ensuring that the annotations 425 are correctly transferred even if the views of the objects 320 are partially obscured or fully obscured in certain views. The purpose of the annotation propagation subsystem 210 and the annotation propagation module 540 is to automate and enhance the annotation process across multiple images of the same object/feature in the environment, minimizing manual labeling efforts while maintaining high spatial accuracy and consistency. In other words, in the example shown in FIGS. 2-5, a single annotated image 410 of an object or feature can be used to transfer the annotation 425 (provided, for example, by a human user or by an object recognition system) on the image 410 to numerous other non-annotated images taken at various different distances and/or from different perspectives, to provide new annotated 2D images (such as the new annotated output images 430 and 440 shown in FIG. 4).

The annotation propagation subsystem 210 is also configured to provide instructions to the annotation propagation module 540 to manage the dynamic aspects of the 3D model construction and annotation propagation as the one or more machines 116 navigate through the changing environment. The annotation propagation subsystem 210 provides instructions to the annotation propagation module 540 to continuously update the 3D model 420 to accurately reflect real-time changes in both the environment and the position of the one or more machines 116, ensuring that the annotations on the 2D images remain consistent despite any alterations.

To this end, the annotation propagation subsystem 210 provides instructions to the cross-viewpoint synchronization sub-module 544 to employ a cross-viewpoint synchronization to align the annotation 425 with the images across various viewpoints (in other words, to align the annotated 2D image 410 of an object/feature with non-annotated 2D images of the same object/feature), accounting for differences in camera angles and positions. This approach ensures that the annotations 425 are accurately transferred from the annotated 2D image 410 to the non-annotated images of the same object/feature and maintained across all the one or more images, regardless of how the one or more machines 116 move and how the scene associated with the environment evolves. In this manner, the annotation propagation subsystem 210 is configured to provide real-time, consistent labeling across a dynamic and complex environment, thereby reducing the need for manual intervention (such as having to annotate every 2D image of an object or feature) and enhancing the overall accuracy of the annotations.

As described above, the system 102, via the subsystems 114 of FIG. 2 and the data obtaining module 510, the 3D model construction module 520 and the annotation propagation module 540 of FIG. 5, outputs (via the re-projection sub-module 550, a set of one or more images (such as the output annotated 2D images 430 and 440 of FIG. 4, which were previously non-annotated 2D images input into the data obtaining module 510) with automatically propagated and synchronized annotations based on the 3D model 420 and the sensor data. A significant technical advantage of this operation of the system 102 is that it produces accurately labeled large datasets with minimal human intervention, suitable for applications in artificial intelligence model training, particularly in autonomous robotics, perception systems, construction site monitoring.

FIG. 6 shows a flowchart for constructing the 3D model 420 with dynamic environment data with automated annotation in accordance with aspects of the disclosure. In FIG. 6, in step 610, a three-dimensional (3D) model of an environment, using the sensors located on a machine 116 configured to move through the environment. This is shown, for example, in FIGS. 3 and 4 in which a machine 116 traverses through an environment 315 along a path 310, and uses a first sensor mounted on the machine 116, such as LiDAR, to create a point cloud that is used to construct the 3D model 420 of the environment, as shown in FIG. 4.

In addition to the first sensor configured to obtain point cloud data of the environment, other sensors are mounted on the machine, such as one or more cameras, to obtain a plurality of 2D images of objects or/or features in the environment 315 from different perspectives as the machine 116 moves through the environment 315. In step 610, the collected data includes at least one of annotated 2D image of an object or feature in the environment, which includes an annotation identifying the object or feature, and at least one other non-annotated 2D image of the same object or feature taken from a different perspective or camera angle. Additional sensors, such as wheel encoders and IMUs are also mounted on the machine 116 to monitor position and orientation of the machine 116 as the machine moves through the environment 315, which provides data that ensures accuracy of the data points used to create the point cloud used to generate the 3D model 420. As shown in FIG. 5, all of the data obtained by the sensors on the machine 116 (e.g., the annotated 2D input(s), the non-annotated 2d input(s), the point cloud data, such as LiDAR data, and odometry data from wheel encoders, IMUs, and the like) are input to the data obtaining module 510 to be used of constructing the 3D model 420 and the process of propagating the annotation from the annotated 2D image to one or more non-annotated 2D images, as discussed above.

In step 620, the annotated and non-annotated 2D images obtained from the camera(s) mounted on the machine 116 are projected onto the 3D model 420. This is done by the 2D image projection sub-module 542 in the annotation propagation module 540 of the processor 110, as shown in FIG. 5. An example of this can be seen in FIG. 3 in which only one of the 2D images shown in the multi-view segmentation 325 (specifically, the 2D image 330) is annotated, while the other two 2D images 335 and 340 are non-annotated images.

In step 630, the non-annotated 2D image(s) are aligned with the annotated 2D image(s) on the 3D model. This is showing, for example, in FIG. 3 as the multi-view consistency alignment 360 in the point cloud 350 of the 3-D model 420. This alignment is carried out by the cross-point synchronization sub-module 544, as discussed above.

In step 640, the annotation from the annotated 2D image(s) is projected onto the 3D model 420 to the non-annotated 2D image(s) projected onto the 3D model to convert the non-annotated 2D image(s) to a second annotated 2D image(s). This can be seen, for example, in FIG. 4, in which the annotation 425 on the input annotated 2D image 410 is transferred to the new views 430 and 440 of originally non-annotated images 335 and 340 shown in the multi-view segmentation 325 of FIG. 3. This annotation transfer is carried out by the annotation transfer sub-module 546, as discussed above.

In step 650, the non-annotated 2D image(s) projected onto the 3D model is re-projected as a new second annotated 2D image(s) onto a 2D plane. This can be seen, for example, in FIG. 4, in which the annotation 425 on the input annotated 2D image 410 is transferred to the new views 430 and 440 of originally non-annotated images 335 and 340 shown in the multi-view segmentation 325 of FIG. 3. This re-projection of the new annotated 2D image(s) is carried out by the annotation transfer sub-module 550, as discussed above.

The system, method and computer program product described herein provide the technical advantage of building a detailed 3D model 420 of the environment (e.g., a construction site) in real-time by estimating the machine (e.g., a robot) pose, aggregating LiDAR point clouds (or point clouds built by similar methods), and filtering out noise and dynamic elements such as moving objects. This 3D model 420 serves as a reference framework for all subsequent image annotations, ensuring spatial accuracy and consistency across different viewpoints. Once an object is annotated in a single image, the system leverages the 3D model 420 and the estimated camera poses to propagate this annotation across all other images captured from different angles. This is achieved by projecting the initial 2D annotation into the 3D space and then re-projecting it back into the 2D plane of new images, accounting for camera pose, object occlusions, and changes in perspective.

In addition, the system, method and computer program product described herein has the technical advantage of intelligently estimating potential occlusions by analyzing the 3D model 420, and ensuring that annotations 425 are accurately transferred even when objects are partially or fully obscured in certain views. This involves advanced back-projection techniques, utilizing a back projection sub-module 548, that account for the machine's updated position and the visibility of objects in new image frames.

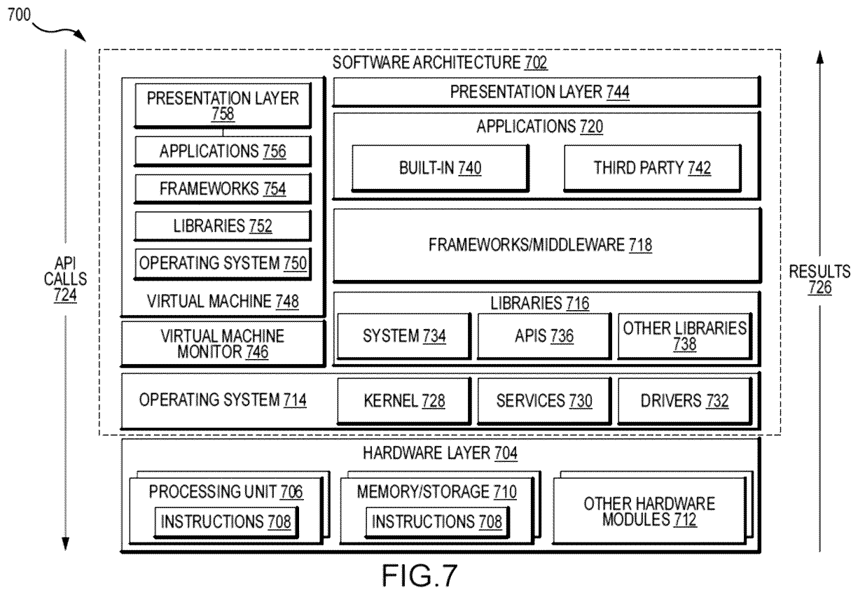

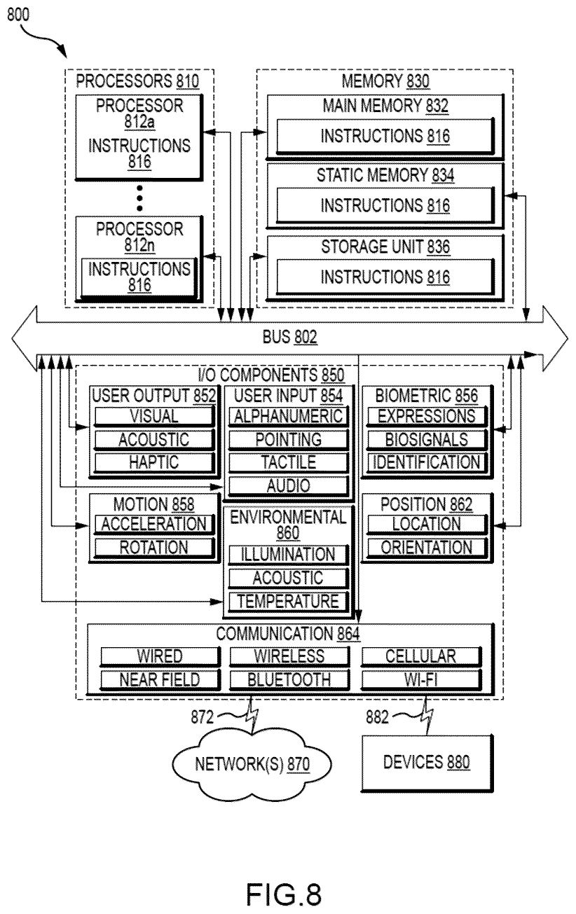

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, components of the satellite communication system 100 and ROHC implementations of FIGS. 1-6. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term ‘machine’ includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term ‘processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for constructing dynamic environment data with an automated annotation, comprising:
a processor; and
a memory in communication with the processor, the memory comprising executable instructions that, when executed by the processor alone or in combination with other processors, cause the system to perform functions of:
constructing a three-dimensional (3D) model of an environment, using a plurality of sensors located on a machine configured to move through the environment, wherein the plurality of sensors include a first sensor configured to obtain point cloud data of the environment, a second sensor configured to obtain a plurality of two dimensional (2D) images of an object or feature in the environment from different perspectives as the machine moves through the environment, and a third sensor configured to monitor position and orientation of the machine as the machine moves through the environment;
receiving a first one of the 2D images of the object or feature in the environment, obtained by the second sensor, wherein the first one of the 2D images is an annotated 2D image which includes an annotation identifying the object or feature;
projecting the annotated 2D images with the annotation onto the 3D model;
projecting a second one of the 2D images of the object or feature, obtained by the second sensor from a different perspective of the object or feature, onto the 3D model, wherein the second one of the 2D images is a non-annotated 2D image;
aligning the non-annotated 2D image projected onto the 3D model with the annotated 2D image projected onto the 3D model;
transferring the annotation from the annotated 2D image projected onto the 3D model to the non-annotated 2D image projected onto the 3D model after the annotated 2D image and the non-annotated 2D image are aligned with one another on the 3D model to convert the non-annotated 2D image to a second annotated 2D image; and
re-projecting the non-annotated 2D image as the second annotated 2D image onto a 2D plane.

2. The system of claim 1, wherein the instructions cause the system to perform a further function of filtering moving objects from the 3D model.

3. The system of claim 1, wherein the first sensor is a light detecting and ranging detector (LiDAR), the second sensor is a camera, and the third sensor is configured to obtain optometry data of the machine moving in the environment.

4. The system of claim 3, wherein the third sensor is at least one of an inertial measurement unit (IMU) and a wheel encoder.

5. The system of claim 1, wherein the instructions cause the system to refine a course image of the object or feature shown in one of the annotated 2D image and the non-annotated 2D image into a more precise image of the object or feature based on a more precise image of the object or feature shown in the other of the annotated 2D image and the non-annotated 2D image.

6. The system of claim 1, wherein the instructions cause the system to perform a further function of enhancing quality of 3D features of the object or feature modeled in the 3D model using a vision foundation model (VFM).

7. The system of claim 6, wherein the VFM model comprises at least one of a distillation of knowledge with no labels (DINO) and contrast of language image pretraining (CLIP).

8. The system of claim 1, wherein the instructions cause the system to perform a further function of enhancing quality of 3D features of the object or feature modeled in the 3D model using a semantic mask.

9. The system of claim 8, wherein the semantic mask is a segment anything model (SAM).

10. The system of claim 1, wherein the instructions cause the system to perform a further function of using back projection procedures to refine placement of the annotation from the annotated the 2D image to the non-annotated 2D image projected onto the 3D model.

11. The system of claim 1, wherein the instructions cause the system to perform a further function of analyzing the 3D model to estimate and manage potential obstructions in the environment to improve accuracy of transferring the annotation from the annotated 2D image to the non-annotated 2D image even though the object or feature of the environment is occluded in the non-annotated 2D image.

12. A method for constructing dynamic environment data with an automated annotation, comprising:
constructing a three-dimensional (3D) model of an environment, using a plurality of sensors located on a machine configured to move through the environment, wherein the plurality of sensors include a first sensor configured to obtain point cloud data of the environment, a second sensor configured to obtain a plurality of two dimensional (2D) images of an object or feature in the environment from different perspectives as the machine moves through the environment, and a third sensor configured to monitor position and orientation of the machine as the machine moves through the environment;
receiving a first one of the 2D images of the object or feature in the environment, obtained by the second sensor, wherein the first one of the 2D images is an annotated 2D image which includes an annotation identifying the object or feature;
projecting the annotated 2D images with the annotation onto the 3D model;
projecting a second one of the 2D images of the object or feature, obtained by the second sensor from a different perspective of the object or feature, onto the 3D model, wherein the second one of the 2D images is a non-annotated 2D image;
aligning the non-annotated 2D image projected onto the 3D model with the annotated 2D image projected onto the 3D model;
transferring the annotation from the annotated 2D image projected onto the 3D model to the non-annotated 2D image projected onto the 3D model after the annotated 2D image and the non-annotated 2D image are aligned with one another on the 3D model to convert the non-annotated 2D image to a second annotated 2D image; and
re-projecting the non-annotated 2D image as the second annotated 2D image onto a 2D plane.

13. The system of claim 12, wherein the instructions cause the system to perform a further function of filtering moving objects from the 3D model.

14. The system of claim 12, wherein the first sensor is a light detecting and ranging detector (LiDAR), the second sensor is a camera, and the third sensor is configured to obtain optometry data of the machine moving in the environment.

15. The system of claim 14, wherein the third sensor is at least one of an inertial measurement unit (IMU) and a wheel encoder.

16. The system of claim 12, wherein the instructions cause the system to refine a course image of the object or feature shown in one of the annotated 2D image and the non-annotated 2D image into a more precise image of the object or feature based on a more precise image of the object or feature shown in the other of the annotated 2D image and the non-annotated 2D image.

17. The system of claim 12, wherein the instructions cause the system to perform a further function of enhancing quality of 3D features of the object or feature modeled in the 3D model using a vision foundation model (VFM).

18. The system of claim 17, wherein the VFM model comprises at least one of a distillation of knowledge with no labels (DINO) and contrast of language image pretraining (CLIP).

19. The system of claim 12, wherein the instructions cause the system to perform a further function of enhancing quality of 3D features of the object or feature modeled in the 3D model using a semantic mask.

20. A computer-readable storage medium having instructions stored thereon that, when executed by a processing system, perform a method comprising:
constructing a three-dimensional (3D) model of an environment, using a plurality of sensors located on a machine configured to move through the environment, wherein the plurality of sensors include a first sensor configured to obtain point cloud data of the environment, a second sensor configured to obtain a plurality of two dimensional (2D) images of an object or feature in the environment from different perspectives as the machine moves through the environment, and a third sensor configured to monitor position and orientation of the machine as the machine moves through the environment;
receiving a first one of the 2D images of the object or feature in the environment, obtained by the second sensor, wherein the first one of the 2D images is an annotated 2D image which includes an annotation identifying the object or feature;
projecting the annotated 2D images with the annotation onto the 3D model;
projecting a second one of the 2D images of the object or feature, obtained by the second sensor from a different perspective of the object or feature, onto the 3D model, wherein the second one of the 2D images is a non-annotated 2D image;
aligning the non-annotated 2D image projected onto the 3D model with the annotated 2D image projected onto the 3D model;
transferring the annotation from the annotated 2D image projected onto the 3D model to the non-annotated 2D image projected onto the 3D model after the annotated 2D image and the non-annotated 2D image are aligned with one another on the 3D model to convert the non-annotated 2D image to a second annotated 2D image; and
re-projecting the non-annotated 2D image as the second annotated 2D image onto a 2D plane.
